(19) United States
(12) Patent Application Publication
(10) Pub. No.: US 2004/0087757 A1
(43) Pub. Date: May 6, 2004

(54) Polyimide film and method for production thereof and method for adjusting isotropy thereof

(76) Inventors: Hidehito Nishimura, Otsu-shi (JP); Kazuhiko Ono, Otsu-shi (JP); Masaru Nishinaka, Otsu-shi (JP); Kiyokazu Akahori, Otsu-shi (JP)

Correspondence Address: Richard G Lione, Brinks Hofer Gilson & Lione, P O Box 10395, Chicago, IL, 60610, US

(21) Appl. No.: 10/432,277

(22) PCT Filed: Nov. 16, 2001
(86) PCT No.: PCT/JP01/10022

(30) Foreign Application Priority Data
Nov. 17, 2000 (JP) 2000-351878

(51) Int. Cl. C08G 73/10

(52) U.S. Cl. 528/353

(57) ABSTRACT

To provide a polyimide film having an original film width of at least 500 mm, whose isotropy in a width direction is improved to have uniform properties, which polyimide film has been apt to cause property difference in the width direction by continuous molding.

The polyimide film has an original film width of at least 500 mm and a thickness of at most 50 μm, wherein the maximum value of MOR-c is at most 1.35 and a tensile elastic modulus is at least 5.0 GPa at any part of the film. The polyimide film is prepared by the method which comprises steps of: forming a green sheet containing a volatile component, and heating the green sheet by transferring the same through a furnace with both ends of the green sheet being fixed, wherein at the heating step, the original film has an orientation axis angle θ of a positive value at both ends in the original film width direction, and temperature is lower than the boiling point of a main volatile component in a zone where the original film is transferred for a distance equal to the film width between both fixed ends.

### TECHNICAL FIELD

The present invention relates to a polyimide film whose isotropy in a width direction is improved to have uniform properties, which polyimide film has been apt to cause property difference in the width direction by continuous molding, a process for preparing the same, and a process for adjusting the isotropy.

### BACKGROUND ART

In case of a polymer such as polyimide which is difficult for melt processing, as a representative example of a process for preparing, the following continuous molding process is used. That is, after a dehydrating agent and a curing agent such as various catalysts are added to a solvent solution such as a non-protonic polar solvent of a polymer material, the solvent solution is cast or coated on a supporter such as a belt or a drum according to a die casting process or a coating process. And then, the film is heated, reacted and dried to impart self-supportability as a film. Thereafter, a film is peeled from the supporter, both ends thereof are fixed with a pin or the like, and passed through a heating furnace while conveying the film to obtain a final film.

By the way, if a film which is not completely dried is heated before passing through a heating furnace in the above-mentioned process, when heating in a heating furnace is carried out while both ends of a film is fixed, a partial difference occurs in the drying and curing state of a film to show a shrinking force in a film. This is the reason why anisotropy occurs in inplanar orientation of a molecular chain. This anisotropy of the inplanar orientation of a molecular chain has close relationship with anisotropy occurred in other properties of a film, in particular, a difference in the properties due to direction such as a coefficient of linear expansion, coefficient of moisture expansion, and elastic modulus. Such the difference in the properties in a film plane becomes a reason for causing a quality difference depending on a place and a direction in a film plane, particularly, a difference in a dimensional change at film processing. This is a great problem in the use of precision parts, for example, a base material for circuit formation and a recording medium. Therefore, there is a demand for improving for maintaining the isotropy of the properties of a film plane.

Then, as a means for obtaining a film having isotropic properties, Japanese Unexamined Patent Publication No. 60-190314 discloses a process for heat treatment within an extending and shrinking rate of ±5% by using a horizontal chucking equipment which can be extended or shrunk in a width direction of a film, when a solvent is evaporated while moving at a heating zone. Japanese Unexamined Patent Publication No. 8-230063 discloses a process for preparing a polymer film in which, among coefficients of linear expansion of longitudinal direction, transverse direction, right 45 degree direction and left 45 degree direction, a ratio of the maximum and the minimum is at most 1.5, by heating at temperature of not higher than a boiling point of a main volatile component from a fixed end of a film to the same length as a film width in a progressing direction in a furnace.

Recently, for the reasons that a dimensional change due to a stress is small and the handling property is excellent, a film having high elastic modulus of at least 4.0 GPa is desired. In particular, since the handling property is excellent, and self-supportability is high even when a thin film is prepared, a film having the tensile modulus of at least 5.0 GPa is desired.

However, the film having a high elastic modulus has a tendency that influence of the above-mentioned inplanar shrinking force and the molecular orientation in a film plane become larger. In particular, since a film having a tensile modulus of at least 5.0 GPa has the remarkable tendency, it is difficult to obtain a film which is isotropic at an arbitrary point in a film plane.

The above-mentioned process disclosed in Japanese Unexamined Patent Publication No. 60-190314 can not be applied to a film having a high elastic modulus which was not used at the present invention, and it is difficult to obtain a film which is isotropic over a whole width direction. In addition, Japanese Unexamined Patent Publication No. 8-230063 discloses a means to measure the coefficient of linear expansion each time and determine a difference in the coefficients. Therefore, it needs labor and time, and it is difficult to evaluate the measured results instantly and reflect them in a process step. In particular, there is a problem that unevenness occurs in the isotropy when a film is thin.

An object of the present invention is to provide a polyimide film having less difference in properties at any point of the film surface, which film is prepared by continuous molding to have reduced thickness and a high elastic modulus, in particular a tensile modulus of at least 5.0 GPa.

### DISCLOSURE OF INVENTION

The present invention relates to a polyimide film having an original film width of at least 500 mm and a thickness of at most 50 μm, wherein the maximum value of MOR-c is at most 1.35 and a tensile elastic modulus is at least 5.0 GPa at any part of the film.

In the above film, it is preferable that the film has a coefficient of linear expansion of at most 2.0×10⁻⁵/° C. at 100 to 200° C., and a coefficient of moisture expansion of at most 2.0×10⁻⁵/% RH when relative humidity ranges from 40% to 80%.

In the above film, it is preferable that the polyimide film is obtained by condensation polymerization of a diamine component and an acid dianhydride component, the diamine component containing at least 25% by mole of paraphenylenediamine.

In the above film, it is preferable that the polyimide film is obtained by condensation polymerization of a diamine component and an acid dianhydride component, the acid dianhydride component containing at least 25% by mole of p-phenylenebis(trimellitic acid monoester acid anhydride).

The present invention also relates to a process for preparing a polyimide film which comprises steps of: forming a green sheet containing a volatile component, and heating the green sheet by transferring the same through a furnace with both ends of the green sheet being fixed, wherein at the heating step, the original film has an orientation axis angle θ of a positive value at both ends in the original film width direction, and temperature is lower than the boiling point of a main volatile component in a zone where the original film is transferred for a distance equal to the film width between both fixed ends.

The present invention also relates to a process for preparing a polyimide film which comprises steps of: forming a green sheet containing a volatile component, and heating the green sheet by transferring the same through a furnace with both ends of the green sheet being fixed, wherein at the heating step, the original film has an orientation axis angle θ of a negative value at both ends in the original film width direction, and temperature is at least 100° C. higher than the boiling point of a main volatile component in a zone where the original film is transferred for a distance equal to the film width between both fixed ends.

The present invention also relates to a process for preparing a polyimide film which comprises steps of: forming a green sheet containing a volatile component, and heating the green sheet by transferring the same through a furnace with both ends of the green sheet being fixed, wherein at the heating step, in the case that the original film has an orientation axis angle θ of a positive value at both ends in the original film width direction, and temperature is lower than the boiling point of a main volatile component in a zone where the original film is transferred for a distance equal to the film width between both fixed ends, and in the case that the original film has an orientation axis angle θ of a negative value at both ends in the original film width direction, temperature is at least 100° C. higher than the boiling point of a main volatile component in a zone where the original film is transferred for a distance equal to the film width between both fixed ends.

### BRIEF DESCRIPTION OF DRAWINGS

FIG. 1 is a view for explaining a film fixed end, a film width Y, and a length X which is the same as a film width taken from the film fixed end in a film moving direction.

FIG. 2 is a view for explaining an orientation axis angle θ. FIG. 2(a) shows the case in which θ is positive and FIG. 2(b) shows the case in which θ is negative.

FIG. 3 is a view showing a position in which a film is sampled at MOR-c measurement.

FIG. 4 is a view showing a change in humidity and a change in a sample elongation at moisture expansion coefficient measurement.

### BEST MODE FOR CARRYING OUT THE INVENTION

The object of the present invention is to obtain a polyimide film having no unevenness in properties in the film width direction, particularly coefficient of linear expansion, coefficient of moisture expansion and elastic modulus even if the film is prepared by a continuous molding process. The continuous molding process is a process in which, after a curing agent is added to a solution of a polymer material, the solvent is formed into a film on a supporter by a die casting process or the like, and the film is heated, reacted and dried on a belt or a drum to impart supportability as a film, and the film is peeled from the supporter, both ends thereof are fixed, and passed through a heating furnace while conveying this film to obtain a final film.

A film-like material in which a polymer resin has been already dissolved in a solvent to have self-supportability is referred to as a green sheet. The green sheet has ability to shrink in a later heating step due to vaporizing an organic solvent contained therein by heating.

Usually, in the heating step of a green sheet, orientation of molecular chains in a film progresses. Even in case of a polymer having a structure in which molecular orientation strongly progresses in this heating step, or in case of a film in which this orientation has great influence on the properties, an isotropic film can be prepared according to the present invention. In this film, the present invention particularly has the effects which could not be obtained previously.

As used herein, “polyimide” in the present invention refers to a polyimide having, in a polymer repeating unit, a unit represented by the following general formula (A):

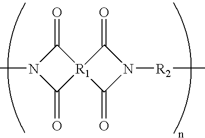

[wherein R₁ is a tetravalent organic group and R₂ is a divalent organic group.]

In a process of forming a film by heating while ends are fixed, there is a tendency that molecular orientation in a film strongly progresses at ends. The present invention is also effective for the film formation in which ends of a polyimide film having the abovementioned structure, in particular, a film having a tensile modulus of at least 5.0 GPa are fixed. For example, even in polyimide having great influence on film properties such as the tensile modulus, the coefficient of linear expansion and the coefficient of moisture expansion, a film having the high isotropy can be formed.

As “polyimide in which orientation strongly progresses by fixation heating and it has great influence on the properties”, for example, there is polyimide having high linearity. R₁ and R₂ in the abovementioned general formula (A) have great influence on the linearity of a polyimide molecule. From such polyimide, a film having a high tensile modulus, in particular, at least 5.0 GPa can be obtained.

Examples of the abovementioned polyimide having the high linearity, specifically include polyimide comprisingf aromatic acid dianhydride and aromatic diamine.

As the abovementioned aromatic diamine component, paraphenylenediamine is preferable from the viewpoint that polyimide exhibiting the extremely high linearity is prepared and a film having a high modulus is obtained. It is preferable that the diamine component contains at least 25% by mole of paraphenylenediamine in the whole diamine component. It is more preferable that it contains at least 33% by mole of paraphenylenediamine. When the content of paraphenylenediamine is smaller than 25% by mole, there is a tendency that the desired elastic modulus (5 GPa) is exhibited with difficulty. And it is preferable that the content of paraphenylenediamine is at most 80% by mole. When the content of paraphenylenediamine is more than 80% by mole, the elastic modulus of the obtained film becomes extremely high (at least 10 GPa), which is not suitable for a base film in a flexible print wiring board.

As the abovementioned aromatic acid dianhydride component, p-phenylenebis(trimellitic acid monoester anhydride) is preferable from the viewpoint that coefficient of linear expansion and coefficient of moisture expansion are small, and polyimide having high dimensional stability is obtained. It is preferable that the acid dianhydride component contains at least 25% by mole of p-phenylenebis(trimellitic acid monoester anhydride) in the whole acid dianhydride component, and it is more preferable that it contains at least 30% by mole. When the content of p-phenylenebis(trimelitic acid monoester anhydride) is smaller than 25% by mole, there is a tendency that the coefficient of moisture expansion becomes large. And it is preferable that the content of p-phenylenebis(trimelitic acid monoester anhydride) is at most 80% by mole. When the content of p-phenylenebis(trimelitic acid monoester anhydride) exceeds 80% by mole, there is a tendency that the elastic modulus becomes high.

When a raw material monomer is used which contains at least 25% by mole of paraphenylenediamine in the whole diamine component and contains at least 25% by mole of p-phenylenebis (polymellitic acid monoester anhydride) in the whole anhydride component, a film having high tensile modulus, small coefficient of linear expansion and coefficient of moisture expansion, and high dimensional stability can be obtained.

A diamine component and an acid dianhydride component other than paraphenylenediamine and/or p-phenylenebis(trimelitic acid monoester anhydride) are not particularly limited, but examples of the diamine component include an aromatic diamine such as diaminodiphenyl ether or diaminodiphenylmethane, an aliphatic diamine, an alicyclic diamine, and the like. Examples of the acid dianhydride component include various acid dianhydrides such as pyromelitic acid dianhydride. The abovementioned diamine component and acid dianhydride component which are raw material monomers for the film of the present invention can be used solely or in combination use of two or more, respectively.

Specifically, preparation of polyimide will be explained. Polyimide represented by the general formula (A) is a condensed polymer prepared using a bifunctional carboxylic anhydride and diamine or diisocyanate as a raw material monomer. In the present invention, polyimide can be prepared, for example, by preparing polyamidic acid which is a precursor for polyimide in a non-protonic polar solvent and, thereafter, heating polyamidic acid to convert into imide. And when it cannot be dissolved in an organic solvent, polyimide can be prepared by heating a mixture of a raw material monomer and/or a curing agent. Examples of the non-protonic polar solvent include N,N-dimethylacetamide, N,N-diethylacetamide, N,N-dimethylformamide, N,N-diethylformamide, N-methyl-2-pyrrolidone and the like. These may be used alone or in a combination use of two or more, in some cases, they may be used together with a poor solvent such as benzene.

The curing agent refers to a reagent which converts polyamidic acid as a precursor for polyimide into imid. Example thereof include a dehydrating agent, a catalyst, and the like. As the dehydrating agent, acetic anhydride is the most popular, but propionic anhydride, butyric anhydride, benzoic anhydride and formic anhydride may be used.

As the catalyst, isoquinoline, pyridine and β-picoline are suitable, but α-picoline, 4-methylpyridine and triethylamine can be used.

In the abovementioned film of polyimide having the high tensile modulus, influence of a shrinking force in a plane becomes large, on the other hand, there is a tendency that molecular orientation in a film plane also becomes strong. In particular, in a film having the tensile modulus of at least 5.0 GPa, since such tendency is remarkable, it was difficult to obtain a film which is isotropic at an arbitrary point in a film.

The polyimide film of the present application is suitably used as a base film for flexible print wiring board. In view of the utility, it is preferable that a polyimide film has an elastic modulus of 5.0 to 10.0 GPa, particularly 5.0 to 7.0 GPa. Even the polyimide film having such modulus can give a film having the isotropy. It is preferable that the coefficient of linear expansion is at most 2.0×10⁻⁵/° C., and the coefficient of moisture expansion is at most 2.0×10⁻⁵/% RH. More preferably, the coefficient of linear expansion is 0.5×10⁻⁵ to 1.5×10⁻⁵/° C., and the coefficient of moisture expansion of at most 1.5×10⁻⁵/% RH.

The present inventors paid attention to the fact that molecular orientation and the isotropy of the properties have the close relationship. That is, it was found that, in order to obtain a film having the isotropy, when MOR-c which is an index for showing the molecular orientation in a film is used as an index for determining the heating conditions in a heating step, a film having small unevenness in the properties in a film plane can be obtained.

Herein, since a sample molded into a film or a sheet is irradiated with microwave, the transmit intensity of absorbed microwave is different due to the anisotropy of the sample, a ratio of a long axis and a short axis in a polar coordinate expressing a difference in the transmit intensity (orientation pattern) is determined to obtain a MOR value, and MOR is used as an index for showing the molecular orientation status. By the way, from the orientation pattern, an orientation angle and a degree of the anisotropy can be obtained. A principle for measuring and a process of measuring are shown below.

(Principle and Process for Measuring MOR-c)

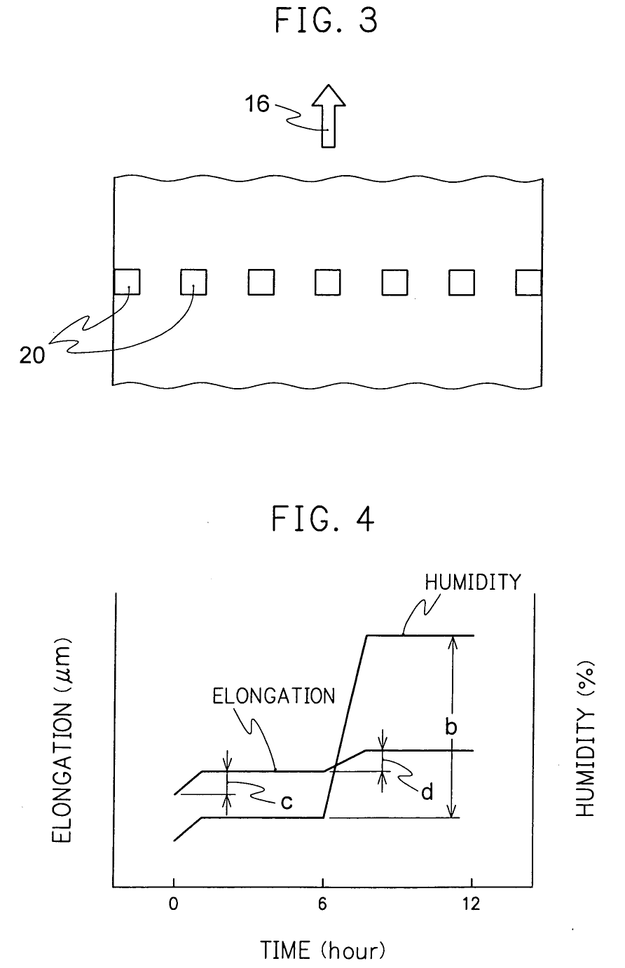

As shown in FIG. 3, seven places are selected at an equal interval including both two side points, samples 20 (4 cm×4 cm) are cut out and a conveying direction is marked on the sample. The MOR value of each sample was measured using a microwave molecular orientation measuring apparatus, Model MOA2012A manufactured by KS-SYSTEMS INC. Measurement of the MOR value with this Model MOA2012A needs a measuring time of only about two minutes per one sample position, and MOR value can be easily measured. Since the MOR value is proportionate with thickness, MOR-c value is a value obtained by converting the MOR value measured by the measuring apparatus into a value at a thickness of 75 μm using the following formula (1).

$$MOR - c = \frac{{t}_{c}}{t} ( MOR - 1 ) + 1 \qquad ( 1 )$$

wherein, t=(thickness of sample)

t_{c}=(standard thickness to be corrected)

MOR=(value obtained by the above measurement)

MOR-c=(MOR value after correction). By substituting 75 for t_{c} in the formula (I), the MOR value after correction is obtained.

It shows that the closer to 1.000 the obtained MOR-c value is, the more isotropic the film is. Therefore, the MOR-c value can be used as an index for simply showing inplanar molecular orientation.

When the maximum of the above MOR-c is at most 1.35, preferably at most 1.30, unevenness in the properties in a film plane is small. That is, a film having isotropic properties can be obtained.

As a film width grows larger, it becomes difficult to obtain an isotropic film at an arbitrary point at a film plane. Therefore, the effects of the present invention are remarkably exhibited in a film of at least 500 mm, preferably at least 1000 mm, more preferably at least 1500 mm.

As used herein, “a raw film width” refers to a minimum length in a width direction of a film obtained by passing through a heating furnace after cast or coated on a supporter in the preparation process, and trimming only fixed ends.

In the present invention, a thickness of 5 to 50 μm is a suitable range.

The process for preparing the polyimide film of the present invention will be specifically explained below. That is, the process for preparing a polyimide film of the present invention comprises a step of forming a green sheet having a volatile component and a heating step of passing it through a heating furnace while both ends of the green sheet are fixed. In the heating step, the heating conditions are set as follows. When an orientational axis angle θ at an end in a raw film width direction is positive, the film is not heated at temperature of at least a boiling point of a main volatile component from a film fixed end to the same length as a film width in a machine direction in a furnace. When an orientational axis angle θ is negative, the film is heated at temperature of 100° C. not less than the boiling point of the main volatile component to the same length as a film width in a machine direction in a furnace.

A green sheet can be formed by the usual manner. For example, polyamidic acid is prepared in a non-protonic polar solvent, after a curing agent is added thereto if necessary, the solution is cast or coated on a supporter such as a belt or a drum, and heated. The heating conditions are suitably determined depending on film thickness. Heating temperature is 30 to 200° C., preferably 50 to 180° C., and heating time is 20 seconds to 20 minutes, preferably 40 seconds to 15 minutes. When the heating temperature is lower than 30° C., it takes longer time until a green sheet having self-supportability is obtained after casting, resulting in lack of productivity. When the heating temperature exceeds 200° C., since it exceeds a boiling point of a dehydrating agent for chemical conversion into imide, there is possibility that the sufficient function as the dehydrating agent can not be exerted. The heating temperature may be set at a constant temperature during casting to peeling of the green sheet, or the temperature may be step-wisely set after casting. Since the heating time has close relationship with the heating temperature, the above time is suitable in view of productivity.

In the step of forming a green sheet, it is preferable that the content of a volatile component in a green sheet is adjusted to 10 to 500 % by weight, particularly 20 to 400% by weight. When the content of a volatile component is less than 10% by weight, a green sheet is floated up from an endless belt, a sheet is greatly shrunk in a width direction, and there is a tendency that a film having the desired uniform width and thickness can not be obtained.

In addition, the content of a volatile component exceeds 500 % by weight, since self-supportability of green sheet is not sufficient, there arises a problem in conveyance of a heating furnace. And it becomes difficult to obtain a film having isotropy.

Here, the content of a volatile component is calculated by the following formula.

Content of volatile component (%)=(weight of contained solvent)÷(weight of polyimide solid)×100

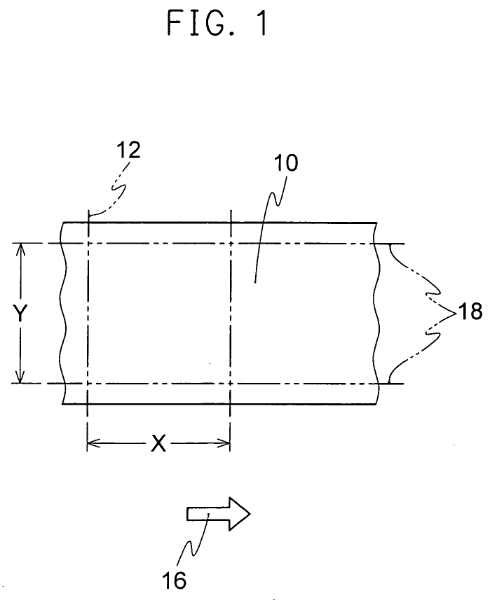

“Film fixed end” refers to a position at which both ends of the green sheet are started to be fixed when the green sheet 10 exhibiting self-supportability is passed through a heating furnace, as shown in FIG. 1. In FIG. 1, reference numeral 12 represents a film fixed end, 16 represents a machine direction of the film, and reference character Y represents a raw film width. Reference character X is the same length as a film width taken in a film machine direction 16. Reference numeral 18 represents a position on a film which is fixed with a fixing equipment at the heating step. As a process for fixing a film, there are optional processes such as a process using a pin, a process using a clip and the like, but not particularly limited thereto. In any case, the effect of the present invention does not substantially differ.

At the heating step, “the film is not heated at temperature of at least boiling point of a main volatile component from a film fixed end to the same length as a film width in a machine direction in a furnace” means that, when Y is adopted as a raw film width, while a film moves from a film fixed end 12 to length of at least X, drying and curing are performed without heating at temperature of at least a boiling point of a main volatile component in and outside a furnace.

Similarly, “the film is heated at temperature of at least 100° C. higher than a boiling point of a main volatile component from a film fixed end to the same length as a film width in a machine direction in a furnace” means that, while a film moves to a length of X, the film is heated at temperature of at least 100° C. higher than a boiling point of a main volatile component.

“Main volatile component” in the present invention is defined as a volatile component having a maximum weight ratio in the total volatile component, or a volatile component in an amount of at least 30% by weight of the total volatile component among volatile components contained in a step of casting or coating a solution of polyamidic acid in an organic solvent and a curing agent to be added if necessary, on a supporter such as a belt and a drum and heating and drying it (namely, a green sheet preparing step), namely, a volatile component comprising an organic solvent which dissolves a raw material monomer, a curing agent and reactive water.

In the present invention, in the abovementioned heating step, an orientational axis angle θ as an index for the heating conditions is defined as follows.

(Definition of Orientational Axis Angle θ)

When MOR-c is measured using Model MOA2012, an orientational direction of a molecule in a film plane (maximum direction of ε′, wherein ε′ is a dielectric constant of a sample) can be obtained as a value of an angle. In the present invention, a straight line showing an orientational direction is an “orientational axis” of the sample.

Here, an orientational axis angle θ is defined as follows:

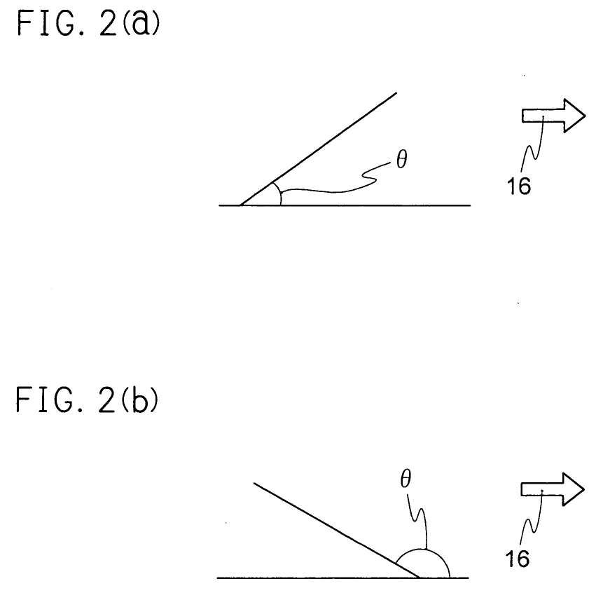

As shown in FIG. 2, x axis is taken at a film end part, and a film machine direction 16 is adopted as a positive direction. Upon this, an angle between a positive direction of x axis and an orientational axis obtained by the abovementioned measurement is adopted as an orientational axis angle θ. The case of 0<θ≦90° as defined as positive (FIG. 2(a)), and the case of 90°≦θ<180° is defined as negative (FIG. 2(b)).

In an orientational axis angle θ, an axial tilt is particularly large at both sides of the raw film. Therefore, an orientational axis angle at both sides of a film can be easily adopted as an index for determining the heating conditions.

In the present invention, by sorting into the positive orientational axis degree θ case and the negative orientational axis degree θ case and determing the conditions of heating at a constant distance in a film machine direction at a heating step by using a boiling point of a main volatile component as a parameter, it becomes possible to prepare a film in which the maximum of MOR-c value is at most 1.35 at any place in a film and anisotropy of the various properties is overcome, and it becomes possible to adjust isotropy.

Specifically, when an orientational axis degree θ at an end part in a width direction of a raw film is positive, the film is not heated at temperature of at least a boiling point of a main volatile component from a film fixed end to the same length as a film width in a machine direction in a furnace. Further, it is preferable to heat at temperature of 0 to 120° C. lower than a boiling point of a volatile component. More preferably, it is preferable to heat at temperature of 5 to 70° C. lower than a boiling point of a volatile component. When heated at temperature higher than a boiling point of a volatile component, a film having isotropy can not be obtained. When heating temperature is too low as compared with a boiling point, conversion into imide of a film by heating does not progress, and there is a tendency of adversely influencing on the physical properties of the finally obtained polyimide film.

When an orientational axis degree θ is negative, temperature of an area up to the same length as a film width in a machine direction in a furnace is at least 100° C. higher than a boiling point of a main volatile component. Further, it is preferable to heat at temperature 100 to 400° C. higher than a boiling point of a volatile component. More preferably, it is preferable to heat at temperature 100 to 300° C. higher than a boiling point of a volatile component. When the temperature is lower than a boiling point of a volatile component +100° C., a film having the isotropy can not be obtained. When the heating temperature is too high as compared with a boiling point, an amido group which is a precursor for imide is thermally degraded and deteriorated by calcinating at high temperature before complete conversion into imide, resulting in a tendency of adversely influencing on the properties of the finally obtained polyimide film.

The present invention will be explained specifically based on the following Examples, but the present invention is not limited thereto.

### EXAMPLE 1

P-phenylenebis(trimellitic acid monoester anhydride)/pyromelitic dianhydride/4,4′-diaminodiphenyl ether/paraphenylenediamine were polymerized at a molar ratio of 1/1/1/1, respectively, in a solvent of N,N-dimethylacetamide (boiling point 164.5 to 166° C.), so that the solid component became 18%.

This polymerization solution was cooled to about 0° C., and 20% by weight of acetic anhydride and 5% by weight of isoquinoline which had been cooled to about 0° C. were added to this polymerization solution. The solution was stirred sufficiently, extruded through a die maintained at about 5° C., and taken off on an endless belt by adjusting lip clearance of a die so that the width became about 1 m and a thickness of a resin containing a volatile component became 0.10 mm (about 12.5 μm after drying). By heating at 85° C. for about 5 minutes on the endless belt, an amount of the volatile component was adjusted to 50% by weight relative to a weight of a film.

This green sheet having self-supportability was peeled, and heated at 300° C. for 30 seconds so that temperature became at least 100° C. higher than a boiling point of N,N-dimethylacetamide which is a main volatile component during about 2 m progression from a fixed end, while both ends of the sheet were fixed to a pin sheet which transfers the sheet continuously. Temperature when the film sheet was transferred for about 1 m which is equal to the width was at least 100° C. higher than a boiling point of the volatile component. Subsequently, the film sheet was introduced into a heating furnace at 400° C., 450° C. and 500° C. to heat for 30 seconds, respectively. Temperature was slowly dropped to room temperature over 1 minute in a slow-cooling furnace, and the film was peeled from the pin when it was conveyed out from the slow-cooling furnace. From fixing to the pin until peeling off, the film was conveyed continuously in the state that both sides were fixed while a film width was persistently retained constant.

From the film which had been peeled out, thereafter, of which 15 mm from both ends had been trimming-treated, as shown in FIG. 3, seven samples having a size of 4 cm×4 cm were taken at an equal interval in a width direction including the two ends. The inplanar orientation state was measured, and the MOR-c values were measured in four directions, that is, a film conveying direction (longitudinal direction), a width direction, (transverse direction), and slant directions (left 45° direction and right 45° direction relative to a film conveying direction: hereinafter, referred to as a slant direction 1 and a slant direction 2, respectively). In this case, θ at both ends of the sample was negative. The results thereof are shown in Table 1.

### COMPARATIVE EXAMPLE 1

For comparison, a green sheet was heated at 200° C. which is lower than temperature of at least 100° C. higher than a boiling point of the main volatile component, for 30 seconds during about 2 m progression from a fixed end in the state of being fixed to a pin sheet according to the same manner as that of Example 1. The sheet was introduced into a heating furnace at 350° C., 450° C. and 500° C., and heated for about 30 seconds, respectively. Temperature when the film sheet was transferred about 1 m which is equal to the above width was lower than a boiling point of the above volatile component +100° C. According to the same procedures as those of Example 1 after a slow cooling furnace, a film was obtained. According to the same sampling process and measurement as those of Example 1, MOR-c value was measured. In this case, θ of both ends of the sampled film were negative. The results thereof are shown in Table 1.

### EXAMPLE 2

Using the same polymer as that in Example 1, this polymerization solution was cooled to about 0° C., 20% by weight of acetic anhydride and 5% by weight of isoquinoline which had been cooled to about 0° C. were added to this polymerization solution. The solution was stirred sufficiently, extruded through a die maintained at about 5° C., dried, and taken up on an endless belt so that a width became about 1 m and the thickness of the resin containing the volatile component became 0.40 mm (thickness of a film after drying was about 50 μm). By heating at 80° C. for about 15 minutes on the endless belt, the amount of the volatile component was adjusted to 50% by weight based on the weight of a film.

This green sheet having self-supportability was peeled, heated for 30 seconds at 150° C. which was lower than a boiling point of N,N-dimethylacetamide as a main volatile component during about 1 m move from a fixed end while both ends of a sheet were fixed to a pin sheet which transferred the sheet continuously. Subsequently, the sheet was introduced in a heating furnace at 300° C., 400° C. and 500° C. to heat for 120 seconds, respectively. Temperature when the film sheet was transferred for about 1 m which is equal to the above width was lower than the boiling point of the above volatile component. Temperature was slowly dropped to room temperature over 3 minutes in a slow-cooling furnace, and the film was conveyed out from the slow-cooling furnace and the film was peeled from the pin. The film was conveyed while both ends were continuously fixed and the film width was persistently retained constant from fixation to the pin to peeling.

Thereafter, according to the same manner as that of Example 1, seven samples were obtained, and the MOR-c value was measured. In this case, θ at both sides of the sampled film was positive. The results thereof are shown in Table 1.

### COMPARATIVE EXAMPLE 2

According to the same manner as that of Example 2, a green sheet was fixed to a pin sheet and, in that state, the sheet was heated at 300° C. for 2 minutes so that temperature became higher than a boiling point of N,N-dimethylacetamide as a main volatile component during about 1 m moving from a fixed end. The sheet was introduced in a heating furnace at 400° C., 450° C. and 500° C. to heat for about 2 minutes, respectively. Temperature when a film sheet was transferred for about 1 m which is equal to the above width was higher than a boiling point of the volatile component. According to the same procedures as those of Example 3 after the slow-cooling furnace, a film was obtained. A sampling process and measurement items were the same as those of Example 2. In this case, θ at both ends of the sampled film was positive. The results thereof are shown into Table 1.

### EXAMPLE 3

According to the same manner as that of Example 1 and using the same compounds as those of Example 1, N,N-dimethylformamide (boiling point 153° C.) was used instead as a solvent, and a varnish was polymerized so that the amount of a solid component became 15%. This polymerization solution was cooled to about 0° C., 20% by weight of acetic anhydride and 5% by weight of isoquinoline which had been cooled to about 0° C. were added to this polymerization solution. The solution was stirred sufficiently, extruded through a die maintained at about 5° C., lip clearance of a die was adjusted so that the width became about 1.5 m and the thickness of the resin containing a volatile component became 0.10 mm (about 12.5 μm after drying), and the film was taken up on the endless belt. By heating at 85° C. for about 5 minutes on the endless belt, the amount of a volatile component was adjusted to 50% by weight based on the weight of the film.

This green sheet having self-supportability was peeled, and heated at 280° C. for 30 seconds so that temperature became at least 100° C. higher than a boiling point of N,N-dimethylformamide as a main volatile component during about 2 m moving from a fixed end while both ends of the sheet were fixed to a pin sheet which transferred the sheet continuously. Temperature when the film sheet was transferred for about 1 m which is equal to the above width was at least 100° C. higher than a boiling point of the volatile component. Subsequently, the sheet was introduced in a heating furnace at 350° C., 450° C. and 500° C., and heated for 30 seconds, respectively. Temperature was dropped to room temperature over 1 minute in a slow-cooling furnace, and the sheet was conveyed out from the slow-cooling furnace and the film was peeled from the pin. The film was conveyed while both ends were continuously fixed and the film width was persistently retained constant from fixation to the pin to peeling.

According to the same manner as that of Example 1, seven samples were obtained from the peeled film, and the MOR-c values in four directions were measured. In this case, θ at both ends of the sampled film was negative. The results thereof are shown in Table 1.

### COMPARATIVE EXAMPLE 3

For comparison, according to the same manner as that of Example 3, a green sheet was fixed to a pin sheet and, in that state, the sheet was heated for 30 seconds at 200° C. which was lower than temperature of at least 100° C. higher than a boiling point of a main volatile component during about 2 m moving from a fixed end, the sheet was introduced into a heating furnace at 350° C., 450° C. and 500° C., and heated for about 30 seconds, respectively. Temperature when a film sheet was transferred for about 1 m which is equal to the above width was lower than the boiling point of a volatile component +100° C. According to the same procedures as those of Example 1 after the slow-cooling furnace, a film was obtained. According to the same sampling process and measurement items as those of Example 1, the MOR-c values were measured. In this case, θ at both ends of the sampled film was negative. The results are shown in Table 1.

### EXAMPLE 4

The same polymerization solution and the curing agent as those in Example 3 were used, and the solution was extruded through a die according to the same manner as that of Example 3, lip clearance of the die was adjusted so that the width became about 1.5 m and the thickness of the resin containing the volatile component became 0.40 mm (about 50 μm after drying), and the sheet was taken up on an endless belt. By heating at 85° C. for about 5 minutes on an endless belt, the amount of the volatile component was adjusted to 50% by weight based on the weight of the film.

This green sheet having self-supportability was peeled, heated for 30 seconds at 135° C. lower than a boiling point of N,N-dimethylformamide as the main volatile component during about 1 m moving from a fixed end while both ends of the sheet were fixed to a pin sheet which transferred the sheet continuously, introduced into a heating furnace at 350° C., 450° C. and 500° C., and heated for 30 seconds, respectively. Temperature when the film sheet was transferred for about 1 m which is equal to the above width was lower than a boiling point of the volatile component. Temperature was slowly dropped to room temperature over 1 minute in a slow-cooling furnace, and the sheet was conveyed out from the slow-cooling furnace and the film was peeled from the pin. The film was conveyed while both ends are continuously fixed and the film width was persistently retained constant from fixation to the pin to peeling.

According to the same manner as that of Example 1, seven samples were taken from the peeled film, and the MOR-c values were measured. In this case, θ at both sides of the sampled film was positive. The results are shown in Table 1.

### COMPARATIVE EXAMPLE 4

For comparison, according to the same manner as that of Example 4, a green sheet was fixed to a pin sheet and, in that state, the sheet was heated at 280° C. for 30 seconds so that temperature became higher than a boiling point of a main volatile component during about 1 m moving from a fixed end. The sheet was introduced into a heating furnace at 350° C., 450° C. and 500° C., and heated for about 30 seconds, respectively. Temperature when the film sheet was transferred for about 1 m which is equal to the above width was higher than the boiling point of the volatile component. According to the same procedures as those of Example 1 after the slow-cooling furnace, a film was obtained. According to the same sampling process and measurement items as those of Example 1, the MOR-c values were measured. In this case, θ at both sides of the sampled film was positive. The results are shown in Table 1.

### COMPARATIVE EXAMPLE 5 (50 μM)

Benzophenone tetracarboxylic acid/pyromelitic dianhydride/4,4′-diaminodiphenyl ether/paraphenylenediamine were polymerized in a molar ratio 2/1/1/2 in a solvent of dimethylformamide so that the amount of a solid component became 18%. This polymerization solution was cooled to about 0° C., and 10% by weight of acetic anhydride and 10% by weight of isoquinoline were added to this polymerization solution. The solution was sufficiently stirred, extruded through a die, dried, and taken up on an endless belt so that the width became about 1 m and the thickness became 50 μm. After heated at 70° C. for about 8 minutes on the endless belt, a green sheet having the solid content of about 50% and self-supportability was peeled, both ends of the sheet was fixed to a pin sheet which transferred the sheet continuously. Firstly, the sheet was introduced into a heating furnace at 80° C. to heat for 1 minute, subsequently introduced in a heating furnace at 150, 300, 450° C. to heat in each heating furnace for 1 minute, respectively. The sheet was conveyed out from a slow-cooling furnace and the film was peeled from the pin. The film was conveyed at 2 m/min while both ends were persistently fixed continuously from fixation to the pin to peeling.

According to the same sampling process and measurement items as those in Example 1, the MOR-c values were measured. The results are shown in Table 1.

### COMPARATIVE EXAMPLE 6 (12.5 μM)

Benzophenon tetracarboxylic acid/pyromellitic dianhydride/4,4′-diaminodiphenyl ether/paraphenylenediamine were polymerized in a moler ratio 2/1/1/2 in a solvent of dimethylformamide so that the amount of the solid component became 18%. This polymerization solution was cooled to about 0° C., and 10% by weight of acetic anhydride and 10% by weight of isoquinoline were added to this polymerization solution. The solution was sufficiently stirred, extruded through a die, dried, and taken up on an endless belt so that the width became about 1 m and the thickness became 12.5 μm. After heated at 60° C. for about 8 minutes on the endless belt, a green sheet having the solid component concentration of about 50% and self-supportability was peeled, and both ends of the sheet were fixed to a pin sheet which transferred the sheet continuously. Firstly, the sheet was introduced in a heating furnace at 80° C. to heat for 1 minute, and introduced into heating furnaces at 150, 300 and 450° C. to heat in each heating furnace for 1 minute, respectively. The sheet was conveyed out from a slow-cooling furnace and the film was peeled from the pin. The film was conveyed at 2 m/min while both ends were persistently fixed continuously from fixation to the pin to peeling. According to the same sampling process and measurement items as those in Example 1, the MOR-c values were measured. The results are shown in Table 1.

TABLE 1

| | MOR-c value | | | | | | |
|---|---|---|---|---|---|---|---|
| | (measured at 7 points equally spaced in the width | | | | | | |
| | direction starting from the film edge) | | | | | | |
| | (1) | | | (4) | | | (7) |
| | (edge) | (2) | (3) | (middle) | (5) | (6) | (edge) |
| Ex. 1 | 1.32 | 1.06 | 1.15 | 1.05 | 1.07 | 1.00 | 1.14 |
| Ex. 2 | 1.17 | 1.12 | 1.10 | 1.12 | 1.24 | 1.30 | 1.35 |
| Ex. 3 | 1.30 | 1.27 | 1.15 | 1.10 | 1.04 | 1.02 | 1.27 |
| Ex. 4 | 1.21 | 1.13 | 1.05 | 1.00 | 1.02 | 1.09 | 1.26 |
| Com. Ex. 1 | 1.97 | 1.50 | 1.25 | 1.12 | 1.16 | 1.39 | 1.75 |
| Com. Ex. 2 | 1.45 | 1.33 | 1.23 | 1.28 | 1.35 | 1.50 | 1.65 |
| Com. Ex. 3 | 1.90 | 1.40 | 1.35 | 1.25 | 1.30 | 1.44 | 1.72 |
| Com. Ex. 4 | 1.35 | 1.22 | 1.15 | 1.15 | 1.11 | 1.30 | 1.50 |
| Com. Ex. 5 | 1.62 | 1.48 | 1.28 | 1.10 | 1.26 | 1.50 | 1.57 |
| Com. Ex. 6 | 1.85 | 1.60 | 1.22 | 1.12 | 1.25 | 1.61 | 1.90 |

(Thickness in Example 1, 2 and Comparative Example 1, 2 is about 12.5 μm, and thickness in Example 3, 4 and Comparative Example 3, 4 is about 50 μm.)

As can be seen from the results in Table 1, in case of positive θ, without heating at temperature higher than a boiling point of a main volatile component until the same length as a film width from a film fixed end and, in case of negative θ, by heating at temperature at least 100° C. higher than a boiling point of a main volatile component until the same length as that of a film width, a film can be obtained which has a MOR-c value of at most 1.35 over the whole width of the film.

Next, the correlation between the MOR-c value and the film properties such as the coefficient of linear expansion, coefficient of moisture expansion and the tensile modulus are examined, and it is shown that when the MOR-c value is 1.35 or smaller, unevenness in the properties is small. Regarding each property value, unevenness is determined to be present when there is a difference of 0.3×10⁻⁵/° C. or more in the case of the coefficient of linear expansion, a difference of 0.2×10⁻⁵/% RH or more in the case of the coefficient of moisture expansion, or a difference of 0.5 GPa or more in the case of the tensile modulus.

(Coefficient of Linear Expansion)

The coefficient of linear expansion was measured at 100 to 200° C. under the nitrogen stream with TMA-8140 made by Rigakudenki.

(Coefficient of Moisture Expansion)

Regarding the coefficient of moisture expansion, the humidity was changed as shown in FIG. 4, the change in the humidity and the change in elongation of the sample were measured simultaneously, and the humidity elongation rate was calculated according to the following equation (calculation temperature: 50° C.).

Coefficient of moisture expansion={(moisture absorption elongation (d))÷(sample length+c)}÷(change in humidity (b))×100

c=(thermal expansion when temperature is raised from room temperature to measurement temperature after sample setting)

The humidity was changed from a relative humidity of 40% to 80%.

(Tensile Modulus)

The tensile modulus was measured according to ASTM D822.

Regarding seven samples from the films obtained in Examples 1 to 4, and Comparative Examples 1 to 6, MOR-c values, coefficient of linear expansion, coefficient of moisture expansion and tensile modulus in four directions, that is, a film conveyance direction (longitudinal direction), a width direction (transverse direction), and slant diretions 1 and 2 (left 45° direction and right 45° direction relative to a film conveyance direction) were measured. The results are shown in Table 2 to Table 11.

TABLE 2
Property of film obtained in Example 1
Angle of orientation axis: negative, heating temperature: 300/400/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.32 | 1.1 | 1.1 | 1.0 | 1.2 | 0.6 | 0.7 | 0.7 | 0.6 | 6.5 | 6.2 | 6.2 | 6.4 |
| (edge) | | | | | | | | | | | | | |
| (2) | 1.06 | 1.1 | 1.1 | 1.1 | 1.2 | 0.7 | 0.7 | 0.7 | 0.7 | 6.3 | 6.3 | 6.3 | 6.3 |
| (3) | 1.15 | 1.1 | 1.1 | 1.1 | 1.2 | 0.7 | 0.7 | 0.7 | 0.6 | 6.4 | 6.2 | 6.3 | 6.3 |
| (4) | 1.05 | 1.1 | 1.1 | 1.1 | 1.1 | 0.7 | 0.7 | 0.7 | 0.7 | 6.3 | 6.3 | 6.3 | 6.3 |
| (middle) | | | | | | | | | | | | | |
| (5) | 1.07 | 1.1 | 1.1 | 1.1 | 1.1 | 0.7 | 0.7 | 0.7 | 0.6 | 6.3 | 6.3 | 6.3 | 6.3 |
| (6) | 1.00 | 1.1 | 1.1 | 1.1 | 1.1 | 0.7 | 0.7 | 0.7 | 0.7 | 6.3 | 6.3 | 6.3 | 6.3 |
| (7) | 1.14 | 1.1 | 1.1 | 1.1 | 1.2 | 0.7 | 0.7 | 0.6 | 0.7 | 6.3 | 6.3 | 6.4 | 6.2 |
| (edge) | | | | | | | | | | | | | |

TABLE 3
Property of film obtained in Comparative Example 1
Angle of orientation axis: negative, heating temperature: 200/350/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.97 | 1.4 | 0.9 | 1.9 | 0.5 | 1.0 | 0.5 | 1.1 | 0.5 | 7.0 | 5.7 | 5.3 | 7.5 |
| (edge) | | | | | | | | | | | | | |
| (2) | 1.50 | 1.2 | 1.0 | 1.3 | 0.8 | 0.8 | 0.7 | 0.9 | 0.6 | 6.6 | 6.0 | 5.9 | 6.7 |
| (3) | 1.25 | 1.1 | 1.1 | 1.2 | 1.0 | 0.7 | 0.7 | 0.6 | 0.7 | 6.4 | 6.2 | 6.2 | 6.3 |
| (4) | 1.12 | 1.1 | 1.1 | 1.1 | 1.1 | 0.7 | 0.7 | 0.7 | 0.7 | 6.2 | 6.3 | 6.3 | 6.2 |
| (middle) | | | | | | | | | | | | | |
| (5) | 1.16 | 1.1 | 1.1 | 1.1 | 1.1 | 0.7 | 0.7 | 0.7 | 0.6 | 6.2 | 6.3 | 6.3 | 6.2 |
| (6) | 1.39 | 1.2 | 1.1 | 1.0 | 1.3 | 0.7 | 0.7 | 0.8 | 0.6 | 6.4 | 6.2 | 6.5 | 6.2 |
| (7) | 1.75 | 1.3 | 1.0 | 0.7 | 1.7 | 1.0 | 0.5 | 0.5 | 1.1 | 7.0 | 5.7 | 7.2 | 5.5 |
| (edge) | | | | | | | | | | | | | |

TABLE 4
Property of film obtained in Example 2
Angle of orientation axis: positive, heating temperature: 150/300/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.17 | 1.2 | 1.2 | 1.1 | 1.2 | 0.7 | 0.7 | 0.7 | 0.7 | 5.8 | 5.8 | 5.9 | 5.7 |
| (edge) | | | | | | | | | | | | | |
| (2) | 1.12 | 1.1 | 1.1 | 1.1 | 1.2 | 0.7 | 0.7 | 0.7 | 0.7 | 5.8 | 5.8 | 5.9 | 5.7 |
| (3) | 1.10 | 1.1 | 1.1 | 1.1 | 1.2 | 0.7 | 0.7 | 0.7 | 0.7 | 5.8 | 5.8 | 5.9 | 5.8 |
| (4) | 1.12 | 1.2 | 1.2 | 1.1 | 1.2 | 0.7 | 0.7 | 0.7 | 0.7 | 5.7 | 5.9 | 5.9 | 5.9 |
| (middle) | | | | | | | | | | | | | |
| (5) | 1.24 | 1.2 | 1.2 | 1.2 | 1.1 | 0.7 | 0.7 | 0.7 | 0.6 | 5.7 | 5.8 | 5.7 | 5.9 |
| (6) | 1.30 | 1.2 | 1.2 | 1.2 | 1.1 | 0.7 | 0.7 | 0.7 | 0.7 | 6.0 | 5.7 | 5.7 | 6.0 |
| (7) | 1.35 | 1.2 | 1.2 | 1.3 | 1.1 | 0.6 | 0.7 | 0.7 | 0.6 | 6.1 | 5.7 | 5.6 | 6.0 |
| (edge) | | | | | | | | | | | | | |

TABLE 5
Property of film obtained in Comparative Example 2
Angle of orientation axis: positive, heating temperature: 300/400/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.45 | 1.3 | 1.1 | 1.0 | 1.2 | 0.8 | 0.7 | 0.6 | 0.8 | 6.3 | 5.8 | 6.2 | 5.6 |
| (edge) | | | | | | | | | | | | | |
| (2) | 1.33 | 1.2 | 1.2 | 1.1 | 1.2 | 0.7 | 0.7 | 0.7 | 0.8 | 5.8 | 5.8 | 5.9 | 5.7 |
| (3) | 1.23 | 1.2 | 1.2 | 1.1 | 1.2 | 0.7 | 0.7 | 0.7 | 0.7 | 5.8 | 5.8 | 5.9 | 5.8 |
| (4) | 1.28 | 1.2 | 1.2 | 1.1 | 1.2 | 0.7 | 0.7 | 0.7 | 0.7 | 5.7 | 5.9 | 5.9 | 5.9 |
| (middle) | | | | | | | | | | | | | |
| (5) | 1.35 | 1.3 | 1.2 | 1.2 | 1.0 | 0.7 | 0.7 | 0.8 | 0.7 | 5.7 | 5.8 | 5.7 | 5.9 |
| (6) | 1.50 | 1.3 | 1.1 | 1.3 | 1.0 | 0.7 | 0.7 | 0.8 | 0.6 | 6.0 | 5.7 | 5.5 | 6.3 |
| (7) | 1.65 | 1.3 | 1.1 | 1.4 | 0.9 | 0.6 | 0.7 | 0.9 | 0.6 | 6.1 | 5.8 | 5.4 | 6.4 |
| (edge) | | | | | | | | | | | | | |

TABLE 6
Property of film obtained in Example 3
Angle of orientation axis: positive, heating temperature: 280/350/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.30 | 1.1 | 1.1 | 1.0 | 1.2 | 0.6 | 0.7 | 0.7 | 0.6 | 6.4 | 6.2 | 6.2 | 6.4 |
| (edge) | | | | | | | | | | | | | |
| (2) | 1.27 | 1.1 | 1.1 | 1.0 | 1.2 | 0.7 | 0.7 | 0.7 | 0.6 | 6.3 | 6.3 | 6.2 | 6.4 |
| (3) | 1.15 | 1.1 | 1.1 | 1.1 | 1.2 | 0.7 | 0.7 | 0.7 | 0.7 | 6.3 | 6.3 | 6.2 | 6.4 |
| (4) | 1.10 | 1.1 | 1.1 | 1.1 | 1.1 | 0.7 | 0.7 | 0.7 | 0.7 | 6.4 | 6.2 | 6.3 | 6.3 |
| (middle) | | | | | | | | | | | | | |
| (5) | 1.04 | 1.1 | 1.1 | 1.1 | 1.1 | 0.7 | 0.7 | 0.7 | 0.7 | 6.3 | 6.3 | 6.3 | 6.3 |
| (6) | 1.02 | 1.1 | 1.1 | 1.1 | 1.1 | 0.7 | 0.7 | 0.7 | 0.7 | 6.3 | 6.3 | 6.3 | 6.3 |
| (7) | 1.27 | 1.1 | 1.1 | 1.2 | 1.1 | 0.7 | 0.7 | 0.6 | 0.7 | 6.4 | 6.3 | 6.4 | 6.2 |
| (edge) | | | | | | | | | | | | | |

TABLE 7
Property of film obtained in Comparative Example 3
Angle of orientation axis: negative, heating temperature: 200/350/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.90 | 1.4 | 0.9 | 1.8 | 0.7 | 1.0 | 0.5 | 1.1 | 0.6 | 7.0 | 5.8 | 5.5 | 7.2 |
| (edge) | | | | | | | | | | | | | |
| (2) | 1.40 | 1.2 | 1.1 | 1.3 | 0.9 | 0.8 | 0.7 | 0.8 | 0.6 | 6.5 | 6.2 | 6.1 | 6.6 |
| (3) | 1.35 | 1.1 | 1.2 | 1.2 | 1.0 | 0.7 | 0.7 | 0.6 | 0.7 | 6.3 | 6.3 | 6.2 | 6.5 |
| (4) | 1.25 | 1.1 | 1.0 | 1.1 | 1.1 | 0.7 | 0.6 | 0.7 | 0.7 | 6.2 | 6.4 | 6.3 | 6.2 |
| (middle) | | | | | | | | | | | | | |
| (5) | 1.30 | 1.1 | 1.1 | 1.0 | 1.2 | 0.7 | 0.6 | 0.7 | 0.8 | 6.2 | 6.3 | 6.4 | 6.2 |
| (6) | 1.44 | 1.2 | 1.1 | 1.0 | 1.3 | 0.8 | 0.7 | 0.6 | 0.9 | 6.4 | 6.2 | 6.6 | 6.0 |
| (7) | 1.72 | 1.3 | 1.0 | 0.7 | 1.7 | 0.9 | 0.7 | 0.6 | 1.0 | 7.0 | 5.7 | 7.2 | 5.5 |
| (edge) | | | | | | | | | | | | | |

TABLE 8
Property of film obtained in Example 4
Angle of orientation axis: positive, heating temperature: 135/350/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.21 | 1.2 | 1.2 | 1.1 | 1.2 | 0.6 | 0.7 | 0.7 | 0.7 | 5.9 | 5.8 | 5.9 | 5.7 |
| (edge) | | | | | | | | | | | | | |
| (2) | 1.13 | 1.2 | 1.2 | 1.2 | 1.2 | 0.7 | 0.7 | 0.7 | 0.7 | 5.8 | 5.8 | 5.9 | 5.7 |
| (3) | 1.05 | 1.2 | 1.2 | 1.2 | 1.2 | 0.7 | 0.7 | 0.7 | 0.7 | 5.8 | 5.8 | 5.9 | 5.8 |
| (4) | 1.00 | 1.2 | 1.2 | 1.2 | 1.2 | 0.7 | 0.7 | 0.7 | 0.7 | 5.8 | 5.8 | 5.8 | 5.8 |
| (middle) | | | | | | | | | | | | | |
| (5) | 1.02 | 1.2 | 1.2 | 1.2 | 1.2 | 0.7 | 0.7 | 0.7 | 0.7 | 5.7 | 5.8 | 5.8 | 5.8 |
| (6) | 1.09 | 1.2 | 1.2 | 1.2 | 1.2 | 0.7 | 0.7 | 0.7 | 0.7 | 5.8 | 5.8 | 5.8 | 5.9 |
| (7) | 1.26 | 1.2 | 1.2 | 1.3 | 1.2 | 0.6 | 0.7 | 0.7 | 0.6 | 6.0 | 5.8 | 5.7 | 6.0 |
| (edge) | | | | | | | | | | | | | |

TABLE 9
Property of film obtained in Comparative Example 4
Angle of orientation axis: positive, heating temperature: 280/350/450/500(° C.)

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.35 | 1.2 | 1.1 | 1.1 | 1.3 | 0.8 | 0.7 | 0.7 | 0.8 | 5.9 | 5.7 | 6.1 | 5.7 |
| (edge) | | | | | | | | | | | | | |
| (2) | 1.22 | 1.2 | 1.2 | 1.1 | 1.2 | 0.7 | 0.7 | 0.7 | 0.8 | 5.9 | 5.7 | 5.9 | 5.7 |
| (3) | 1.15 | 1.2 | 1.2 | 1.1 | 1.2 | 0.7 | 0.7 | 0.7 | 0.7 | 5.8 | 5.8 | 5.9 | 5.8 |
| (4) | 1.15 | 1.2 | 1.2 | 1.1 | 1.2 | 0.7 | 0.7 | 0.7 | 0.7 | 5.8 | 5.9 | 5.8 | 5.8 |
| (middle) | | | | | | | | | | | | | |
| (5) | 1.11 | 1.2 | 1.2 | 1.2 | 1.2 | 0.7 | 0.7 | 0.7 | 0.7 | 5.8 | 5.8 | 5.8 | 5.9 |
| (6) | 1.30 | 1.2 | 1.2 | 1.2 | 1.1 | 0.7 | 0.7 | 0.8 | 0.7 | 5.9 | 5.7 | 5.7 | 6.1 |
| (7) | 1.50 | 1.3 | 1.1 | 1.4 | 1.0 | 0.8 | 0.7 | 0.9 | 0.6 | 6.0 | 5.7 | 5.6 | 6.3 |
| (edge) | | | | | | | | | | | | | |

TABLE 10
Property of film obtained in Comparative Example 5

| | | Coefficient of linear | | | | Coefficient of moisture | | | | | | | |
|---|---|---|---|---|---|---|---|---|---|---|---|---|---|
| | | expansion (× 10⁻⁵/° C.) | | | | expansion (× 10⁻⁵/% RH) | | | | Tensile modulus (GPa) | | | |
| | MOR-c | | | Dia- | Dia- | | | Dia- | Dia- | | | Dia- | Dia- |
| Measuring | value of | Machine | Width | gonal | gonal | Machine | Width | gonal | gonal | Machine | Width | gonal | gonal |
| position | sample | direction | direction | 1 | 2 | direction | direction | 1 | 2 | direction | direction | 1 | 2 |
| (1) | 1.62 | 1.8 | 1.9 | 2.2 | 1.3 | 1.2 | 1.3 | 1.7 | 1.0 | 6.2 | 6.1 | 5.2 | 6.9 |
| (edge) | | | | | | | | | | | | | |
| (2) | 1.48 | 1.7 | 1.8 | 2.1 | 1.2 | 1.2 | 1.3 | 1.6 | 1.1 | 6.0 | 6.1 | 5.3 | 6.5 |
| (3) | 1.28 | 1.8 | 1.8 | 1.8 | 1.7 | 1.3 | 1.1 | 1.2 | 1.3 | 6.1 | 5.9 | 6.0 | 6.0 |
| (4) | 1.10 | 1.8 | 1.9 | 1.7 | 1.8 | 1.2 | 1.2 | 1.3 | 1.3 | 6.0 | 6.0 | 6.0 | 6.0 |
| (middle) | | | | | | | | | | | | | |
| (5) | 1.26 | 1.7 | 1.8 | 1.8 | 1.8 | 1.3 | 1.3 | 1.3 | 1.3 | 6.1 | 5.9 | 6.0 | 6.0 |
| (6) | 1.50 | 1.8 | 1.8 | 2.2 | 1.3 | 1.2 | 1.2 | 1.6 | 1.2 | 6.1 | 6.1 | 5.5 | 6.7 |
| (7) | 1.57 | 1.7 | 1.9 | 2.3 | 1.2 | 1.3 | 1.3 | 1.8 | 1.2 | 6.0 | 6.1 | 5.6 | 6.7 |
| (edge) | | | | | | | | | | | | | |

TABLE 11
Property of film obtained in Comparative Example 6

| | | Coefficient of linear | | | | | | | | | | | |
|---|---|---|---|---|---|---|---|---|---|---|---|---|---|
| | MOR-c | expansion (×10⁻⁵/° C.) | | | | Coefficient of moisture | | | | Tensile modulus (GPa) | | | |
| | value | | | | Diag- | expansion (×10⁻⁵/% RH) | | | | | | Diag- | Diag- |
| Measuring | of | Machine | Width | Diagonal | onal | Machine | Width | Diagonal | Diagonal | Machine | Width | onal | onal |
| position | sample | direction | direction | 1 | 2 | direction | direction | 1 | 2 | direction | direction | 1 | 2 |
| (1) (edge) | 1.85 | 1.7 | 1.8 | 1.0 | 2.4 | 1.2 | 1.3 | 1.0 | 1.9 | 6.0 | 5.9 | 7.0 | 5.2 |
| (2) | 1.60 | 1.8 | 1.8 | 1.5 | 2.2 | 1.3 | 1.3 | 1.1 | 1.7 | 5.9 | 5.9 | 6.8 | 5.3 |
| (3) | 1.22 | 1.9 | 1.9 | 1.7 | 1.8 | 1.2 | 1.3 | 1.4 | 1.3 | 6.0 | 5.9 | 5.9 | 6.0 |
| (4) | 1.12 | 1.8 | 1.7 | 1.9 | 1.8 | 1.3 | 1.3 | 1.3 | 1.2 | 6.1 | 6.0 | 6.0 | 6.0 |
| (middle) | | | | | | | | | | | | | |
| (7) | 1.90 | 1.9 | 1.8 | 1.1 | 2.4 | 1.1 | 1.2 | 1.1 | 2.0 | 6.1 | 6.0 | 7.1 | 5.3 |
| (edge) | | | | | | | | | | | | | |

From Tables 2 to 11, it can be seen that, when the MOR-c value is 1.35 or smaller, there is small unevenness in the properties in four directions and, conversely, when the value exceeds 1.35, there arises unevenness depending on a direction. In addition, it can be seen that a film having the better isotropy can be obtained by a process for preparing polyimide by setting the temperature conditions in a heating step and a process of adjusting the isotropy of the present invention.

### Industrial Applicability

There is a correlation between the MOR-c value and the important properties such as coefficient of linear expansion, coefficient of moisture expansion and tensile modulus and, when the MOR-c value is large, unevenness in the properties in a film plane becomes large. As a result, in the conventional process, a change rate in a film dimension becomes non-isotropic and there was a problem in designing products using this film.

In particular, miniaturiziation of products is progressed in the FPC field, and importance in the dimensional stability is increased. On the other hand, in a film having a high elastic modulus of 5.0 GPa or greater, it was difficult to obtain a film having isotropy over the whole width direction. The present invention overcomes such problems.

According to the present invention, when the MOR-c value is measured and is found to be at most 1.35, it can be determined that the film is isotropic in the properties such as coefficient of linear expansion coefficient, coefficient of moisture expansion and tensile modulus to an extent that there is no problem upon preparation of FPC. For this reason, it is not necessary to check unevenness in the properties by measuring coefficient of linear expansion, coefficient of moisture expansion and tensile modulus in four directions and, by using the MOR-c value which can be evaluated in a shorter period of time, the inplanar isotropy can be evaluated simply in a shorter period of time. For this reason, it is very effective for obtaining a film having isotropy.

In addition, by determining the heating conditions of the heating step in the process for preparing a polyimide film according to the orientational axis angle measured by a molecular orientation measuring apparatus as an index, a film having high isotropy can be obtained.

1. A polyimide film having an original film width of at least 500 mm and a thickness of at most 50 μm, wherein the maximum value of MOR-c is at most 1.35 and a tensile elastic modulus is at least 5.0 GPa at any part of the film.

2. The polyimide film of claim 1, wherein the film has a coefficient of linear expansion of at most 2.0×10⁻⁵/° C. at 100 to 200° C., and a coefficient of moisture expansion of at most 2.0×10⁻⁵/% RH when relative humidity ranges from 40% to 80%.

3. The polyimide film of claim 1, wherein the polyimide film is obtained by condensation polymerization of a diamine component and an acid dianhydride component, the diamine component containing at least 25% by mole of paraphenylenediamine.

4. The polyimide film of claim 1, wherein the polyimide film is obtained by condensation polymerization of a diamine component and an acid dianhydride component, the acid dianhydride component containing at least 25% by mole of p-phenylenebis(trimellitic acid monoester acid anhydride).

5. A process for preparing a polyimide film which comprises the steps of:
forming a green sheet containing a volatile component, and
heating the green sheet by transferring the same through a furnace with both ends of the green sheet being fixed,
wherein at the heating step, the original film has an orientation axis angle θ of a positive value at both ends in the original film width direction, and temperature is lower than the boiling point of a main volatile component in a zone where the original film is transferred for a distance equal to the film width between both fixed ends.

6. A process for preparing a polyimide film which comprises the steps of:
forming a green sheet containing a volatile component, and
heating the green sheet by transferring the same through a furnace with both ends of the green sheet being fixed,
wherein at the heating step, the original film has an orientation axis angle θ of a negative value at both ends in the original film width direction, and temperature is at least 100° C. higher than the boiling point of a main volatile component in a zone where the original film is transferred for a distance equal to the film width between both fixed ends.

7. A process for preparing a polyimide film which comprises the steps of:
forming a green sheet containing a volatile component, and
heating the green sheet by transferring the same through a furnace with both ends of the green sheet being fixed,
wherein at the heating step, in the case that the original film has an orientation axis angle θ of a positive value at both ends in the original film width direction, and temperature is lower than the boiling point of a main volatile component in a zone where the original film is transferred for a distance equal to the film width between both fixed ends,
and in the case that the original film has an orientation axis angle θ of a negative value at both ends in the original film width direction, temperature is at least 100° C. higher than the boiling point of a main volatile component in a zone where the original film is transferred for a distance equal to the film width between both fixed ends.
